(19) United States
(12) Patent Application Publication
(10) Pub. No.: US 2020/0101686 A1
(43) Pub. Date: Apr. 2, 2020

(54) TOOL HEAD POSITIONING MECHANISM FOR A CONVERTING MACHINE, AND METHOD FOR POSITIONING A PLURALITY OF TOOL HEADS IN A CONVERTING MACHINE

(71) Applicant: PACKSIZE LLC, Sait Lake City, UT (US)

(72) Inventors: Bo Fredander, BRO (SE); Johan Blomberg, Uppsala (SE)

(21) Appl. No.: 16/619,818

(22) PCT Filed: May 11, 2018
(86) PCT No.: PCT/US2018/032311

§ 371 Date: Dec. 5, 2019

(30) Foreign Application Priority Data
Jun. 8, 2017 (SE) 1750727-8

(51) Int. Cl. B31B 50/00

(52) U.S. Cl. CPC B31B 50/006; B31B 50/144; B31B 50/005

(57) ABSTRACT

The present invention relates to a method for positioning a plurality of tool heads in a converting machine for converting sheet material into box templates, comprising: providing a plurality of tool heads located at a first set of individual positions within a converting area, moving the plurality of tool heads within the converting area in a first movement by means of a transport mechanism that is arranged to be coupled individually to each tool head, moving at least one of the plurality of tool heads in relation to the transport mechanism in a second movement, wherein the plurality of tool heads are moved to a second set of individual positions by the first and second movement, and wherein the second movement takes place during the first movement. The invention also relates to a tool heads positioning device.

### TECHNICAL FIELD

The present invention relates to a tool head positioning mechanism and a method for positioning a plurality of tool heads in a converting machine, said converting machine being able to convert fanfold material into box templates.

### BACKGROUND

Machines and processing equipment for converting fanfold materials into box templates are frequently used in many technical fields, especially within shipping and packaging industries. Fanfold material, as understood herein, comprises paperboard, corrugated board, cardboard and similar materials that are suitable for packaging purposes. Generally, the fanfold material is processed by a converting machine having a plurality of tool heads arranged in a converting area to act on the fanfold material and produce box templates by cutting and/or creasing the fanfold material as it passes through the machine.

As is well known within the art, it is especially advantageous to adapt the size and shape of the box templates to the products that are to be stored and transported in them, and it is therefore common to position and reposition the tool heads according to dimensions and properties of each new box templates that is to be produced. In some converting machines, two or more different dimensions of fanfold materials are arranged side by side in the converting area and the tool heads are movable from one to the other, in order to have the machine prepared to deliver box templates of different sizes and shapes without requiring removal of one width of fanfold material and supply of another. The tool heads then operate in one part of the converting area and are moved to another part when box templates of different dimensions are to be produced.

Moving and positioning the tool heads within the converting area is generally performed either by moving one tool head at a time, or by moving all tool heads together and then adjusting them individually to their new positions before operation on the fanfold material can be resumed. The positioning must be achieved quickly and with high precision to minimize the time that the converting machine stands idle and to enable operation at a desired level of quality. Some positioning systems are available today but none of them are able to provide high quality and stable operation of the tool heads while also performing the repositioning and moving quickly.

There is therefore a need for an improved method and device for the positioning of tool heads in a converting machine.

### SUMMARY OF THE INVENTION

The object of the present invention is to eliminate or at least to minimize the problems mentioned above. This is achieved through a tool head positioning device for a converting machine according to the appended independent claim. Thanks to the invention, the positioning can be performed more quickly and with higher precision than in previously known devices. This is achieved thanks to the cooperation of a conveyor arrangement of a joint transport mechanism that moves all tool heads simultaneously and a plurality of individual transport mechanisms that each move one tool head in relation to the conveyor arrangement. Thanks to the combination of a first movement by the conveyor arrangement and a second movement by the individual transport mechanisms, the positioning of the tool heads can be performed quicker and more efficiently than in the known devices for this purpose.

According to one aspect of the invention, the conveyor arrangement comprises a toothed belt. This is especially advantageous in allowing the tool heads to be easily coupled to the belt and to perform the first movement of the conveyor arrangement in a reliable and efficient way. Alternatively, the conveyor arrangement comprises a rack, a belt, a chain or a wire.

According to another aspect of the invention, the conveyor arrangement is permanently coupled to each of the tool heads. Thereby, the positioning requires very few separate components and eliminate the risk of mistakes during coupling and uncoupling of the tool heads to the conveyor assembly.

According to yet another aspect of the invention, the device comprises an attachment mechanism for attaching each tool head to the conveyor arrangement, said attachment mechanism preferably comprising clamps for clamping each tool head to the conveyor arrangement. Thereby, a higher degree of flexibility is achieved in allowing for some tool heads being coupled to the conveyor assembly and moved, and other tool heads staying in their previous positions.

According to a further aspect of the invention, the individual transport mechanisms each comprise a motor connected to the tool head, wherein said motor acts on the conveyor arrangement to move the tool head along the conveyor arrangement.

Thereby, the gear of the motor can use the conveyor arrangement as counter surface and the second movement can be performed in a sturdy and efficient way. Also, the rotation of the gear along the conveyor arrangement allow for a very precise determination of position of the tool head in relation to the conveyor arrangement. Preferably, every tool head is connected to an individual transport mechanism, but in some embodiments one or more of the tool heads may be moved only in the first movement and maintain their relative positions to the conveyor assembly throughout their operation.

According to yet another aspect of the invention, the converting area comprises at least two converting stations arranged side-by-side, and wherein the first set of individual positions is located at one of the converting stations and the second set of individual positions is located at another. Thereby, the combination of the first and second movement will move and reposition the tool heads from one type of sheet or fanfold material to another, to allow for greater flexibility in manufacturing the box templates.

Many additional benefits and advantages of the invention will become readily apparent to the person skilled in the art in view of the detailed description below.

### DRAWINGS

The invention will now be described in more detail with reference to the appended drawings, wherein

FIG. 1 discloses a perspective view of a tool head positioning device according to a preferred embodiment of the present invention;

FIG. 2 discloses a planar view from the side of a tool head of the tool head positioning device of FIG. 1;

FIG. 3 discloses a planar view from the side of an individual transport mechanism of the tool head of FIG. 2 and the conveyor arrangement of the tool head positioning device;

FIG. 4 discloses a planar view of the plurality of tool heads of the tool head positioning device at a first set of individual positions; and

FIG. 5 discloses a planar view of the plurality of tool heads of FIG. 4 at a second set of individual positions.

### DETAILED DESCRIPTION

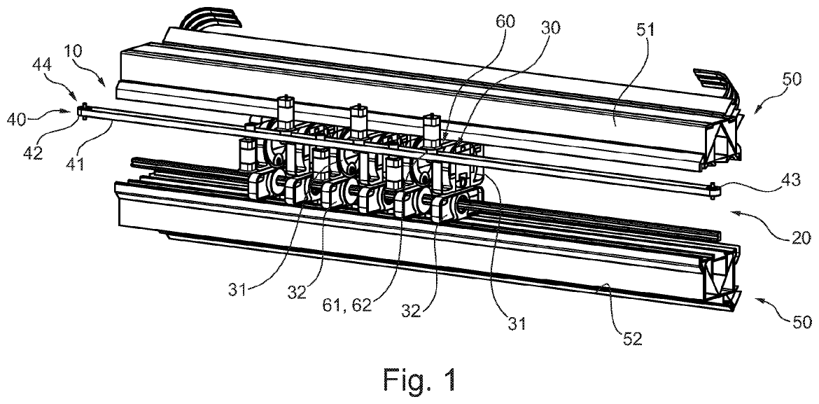

FIG. 1 discloses a preferred embodiment of a tool head positioning device 10 in a converting area 20 of a converting machine for converting sheet material into packaging templates. The sheet material passes from a bale or similar storage area (not shown) through the machine in a first direction and as it passes through the converting area 20, a plurality of tool heads 30 act on the sheet material by cutting and creasing in predetermined places along the sheet material to produce the packaging or box templates that serve as output from the converting machine. Each tool head 31 is connectable to a conveyor arrangement 41 of a joint transport mechanism 40 and can be moved along the conveyor arrangement 41 within the converting area 20 in a direction transversal to the first direction. Preferably, the sheet material is a fanfold material, and in the following the term fanfold will be used throughout, but it is to be noted that other kinds of sheet material may also be used within the scope of the present invention.

The tool heads 30 are held by an upper section 51 of a holding structure 50 and each tool head 31 may be coupled to a corresponding undercarriage 32 that serves as a counter surface for the cutting and creasing operations. The fanfold material thus passes through the converting area 20 between the tool head 31 and the undercarriage 32. The undercarriages 32 are held by a lower section 52 of the holding structure 50. Alternatively, the counter surface for the tool heads 30 may be a roll or cylinder (not shown).

In this preferred embodiment, the conveyor arrangement 41 is a toothed belt that forms an endless belt and runs between a first and a second conveyor wheel 42, 43. Each tool head 31 is permanently coupled to the belt by an individual transport mechanism comprising a motor 61 with a gear 62 that abuts the belt and allow for an individual movement of the tool head 31 in relation to the belt when the gear rotates, as will be described in more detail further below. The aim of the tool head positioning device 10 is to move all the tool heads 30 from a first set of individual positions in the converting area 20, or starting positions, to a second set of individual positions or end positions in the converting area 20. In some cases, this will transport the tool heads 30 from a first converting station 21 in one part of the converting area 20 where they are able to act on one fanfold material to a second converting station 22 in another part of the converting area 20 where they are able to act on another fanfold material, as will be described in more detail further below. In other cases, the tool heads 30 will be transported within the same part of the converting area 20 and will be able to act on the same fanfold material but with at least one of the tool heads 31 being in a different position in the converting area 20 than before the movements.

The conveyor arrangement 41 may also comprise a rack, a chain, or a wire instead of the toothed belt in the preferred embodiment.

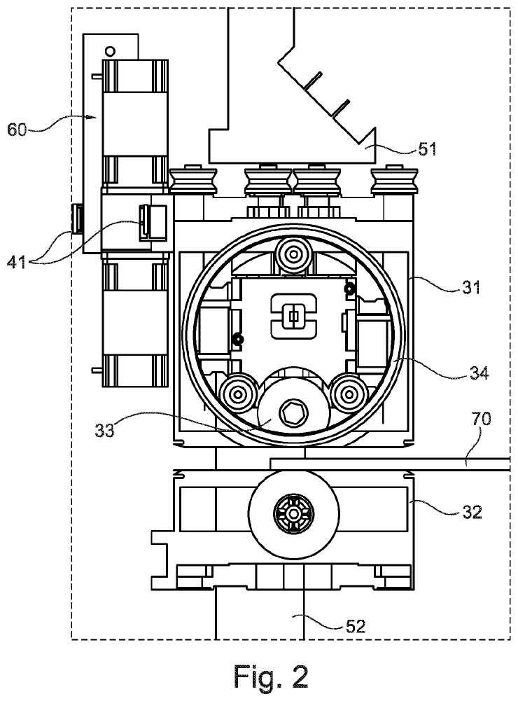

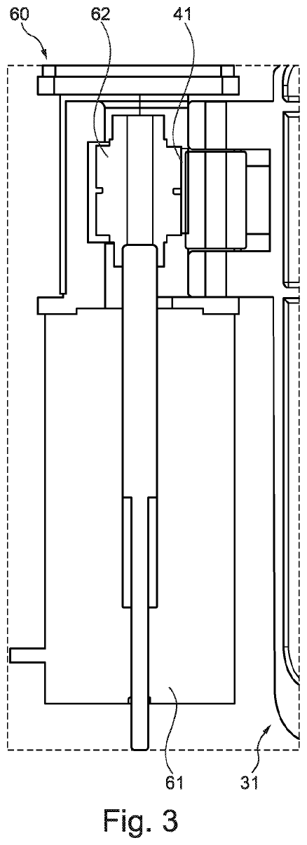

FIG. 2 shows a tool head 31 and an undercarriage 32 with a fanfold material 70 arranged between them. The tool head 31 comprises a cutter 33 and a creaser 34 and is therefore able to act on the fanfold material 70 with both a cutting and a creasing operation. During the conversion operation, the fanfold material 70 passes in the first direction from the right-hand side of FIG. 2 towards the left, but it may also be halted and passed back in the opposite direction before resuming its way in the first direction. FIG. 3 discloses in more detail the individual transport mechanism 60 having a motor 61 and a gear 62 operated by the motor 61 and acting on the conveyor arrangement 41.

The converting area 20 is defined herein as an area in which the tool heads 30 may act on the fanfold material 70 passing through the converting machine, and is in this preferred embodiment of a sufficient width for allowing at least two separate converting stations to be arranged side by side, each converting station holding one type of fanfold material. These different fanfold materials may have different properties and different dimensions, and are generally passed through the converting machine one at a time with the other remaining stationary but able to resume its movement in the first direction when desired. The operation of the converting machine is controlled by a control unit (not shown) that may be arranged to control the movement of the fanfold materials as well as the conversion operations performed by the tool heads 30 and the operation of the tool head positioning device 10. Alternatively, two or more control units may be provided that each control part of the operation of the converting machine and that may or may not communicate with each other, as desired.

The joint transport mechanism 40 comprises at least one motor 44 for operating the first and second conveyor wheels 42, 43 and thereby move the conveyor arrangement 41 so that any given point along the conveyor arrangement 41 is transported in a direction transversal to the first direction. When the tool heads 30 are coupled to the conveyor arrangement 41, this movement of the conveyor arrangement 41 creates the first movement that transports all the tool heads 30 along the width of the converting area 20 and thereby in the direction transversal to the first direction. Thus, the first movement is created by the conveyor arrangement 41 moving together with the tool heads 30.

As already mentioned above, the tool heads 30 are permanently coupled to the conveyor arrangement 41 in this preferred embodiment, and are attached by their individual transport mechanisms 60 each having a gear 62 that is held against the conveyor arrangement 41 and enable the second movement, where each tool head 31 moves in relation to the conveyor arrangement 41.

In another embodiment, one or more of the tool heads 30 may be permanently coupled to the conveyor arrangement 41 without the use of an individual transport mechanism 60, for instance by being firmly clamped onto the conveyor arrangement 41 or mounted in such a way that a second movement of that tool head 31 in relation to the conveyor arrangement 41 is not possible. In such an embodiment, the first movement is used to transport all tool heads 30 until the tool head 31 that is immovably mounted on the conveyor arrangement 41 has reached its intended end position, and the remaining tool heads 31 that have individual transport mechanisms 60 are simultaneously transported to their intended end positions by the second movements that are individually adapted to each tool head 31.

In some embodiments, the tool heads 30 may be released from the conveyor arrangement 41 during the times that they act on the fanfold material. They are then coupled to the conveyor arrangement 41 before the first movement takes place and are uncoupled after they have reached their end positions. The coupling to the conveyor arrangement 41 may be performed through an attachment mechanism comprising clamps or holders, or may be held by friction, magnetism or any other suitable holding force that enable the first movement to be performed with precision and subsequently release the tool heads 30.

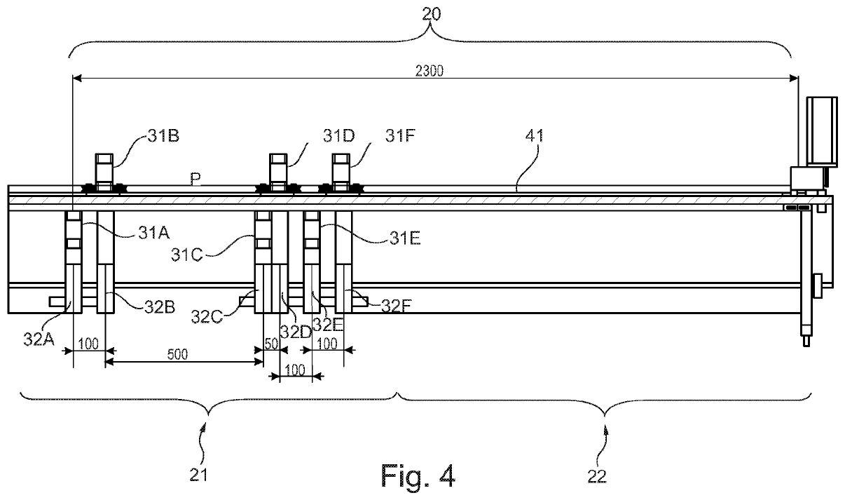

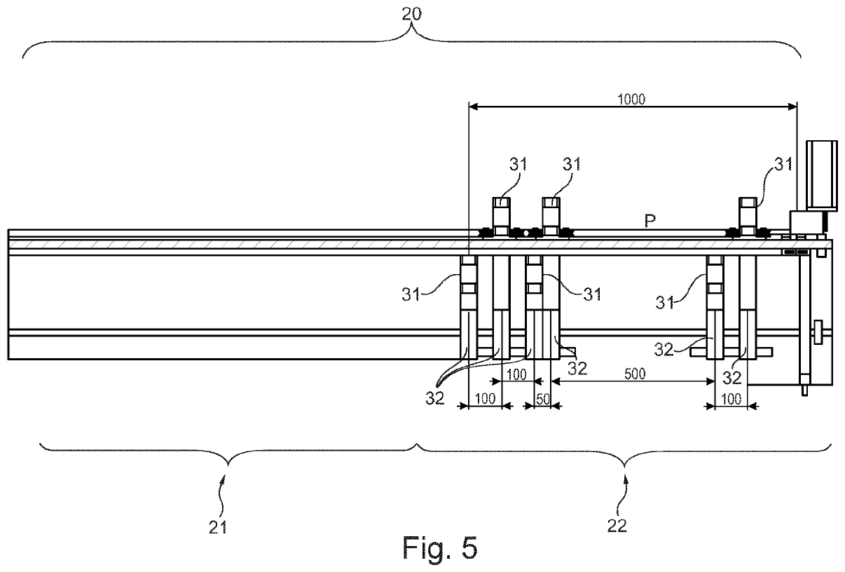

The operation of the tool head positioning device 10 will now be described in more detail with reference to FIGS. 4-5, where FIG. 4 discloses tool heads 31 located at a first set of individual positions in a first converting station 21, and FIG. 5 discloses the same tool heads 31 located at a second set of individual positions in a second converting station 22.

Thus, FIG. 4 discloses six tool heads 31A, 31B, 31C, 31D, 31E, 31F with corresponding undercarriages 32A, 32B, 32C, 32D, 32E, 32F, each located at a starting position within a first converting station 21 and coupled or able to be coupled to the conveyor arrangement 41 of the joint transport mechanism 40. For the sake of simplicity six tool heads are shown, but as is readily understood by the person skilled in the art any number of tool heads can be used without deviating from the scope of the present invention.

For the sake of clarity, one point P on the conveyor arrangement 41 is also shown in order to illustrate the movement of the conveyor arrangement 41 itself. In this embodiment, each tool head 31 is coupled to an undercarriage, but of course any other suitable counter surface may alternatively be used, such as for instance a roll or a cylinder.

When the tool heads are to be transported from the first converting station 21 to the second converting station 22, a suitable combination of first movement for all tool heads 31 together and second movements for each or some of the tool heads 31 are determined, preferably by the control unit. Then, the first movement is performed and the conveyor arrangement moved to the right in FIG. 4 so that each tool head 31A, 31B, 31C, 31D, 31E, 31F is transported along with the conveyor arrangement. This can be illustrated by the point P being moved from its location in the first converting station 21 to a position in the second converting station 22 disclosed by FIG. 5.

During the first movement, at least one of the tool heads 31A, 31B, 31C, 31D, 31E, 31F but preferably a plurality of all of the tool heads 31A-31F perform an individual second movement through which said tool head or tool heads 31A-31F move in relation to the conveyor arrangement 41. This may also be illustrated through a second movement in relation to the point P disclosed by FIGS. 4-5. As can readily be seen by comparing FIG. 4 and FIG. 5, the tool head 31B to the left and the tool head 31D in the middle have been moved closer together by their second movements, whereas the tool head 31D in the middle and the tool head 31F to the right have been moved further apart.

Thanks to the first movement and the individual second movements taking place simultaneously, the entire tool head positioning from the starting positions disclosed by FIG. 4 to the end positions disclosed by FIG. 5 can be performed in a quicker and more reliable way than in the known prior art arrangements and methods. The motor 44 of the joint transport mechanism 40 is larger than the motors 61 of the individual positioning mechanisms 60, and a combination of a stronger motor for the larger movement from the first converting station 21 to the second converting station 22 can advantageously be combined with smaller and more precise movements of the smaller motors of the individual positioning mechanisms 60. Of course, the first set of positions and the second set of positions may be located within the same converting station 21, 22 but it is still advantageous to combine the first movement with the second movements in order to achieve a quick and robust but still highly precise movement of each tool head 31.

FIG. 4 and FIG. 5 show exemplary dimensions of the preferred embodiment described herein, given in mm. This is provided solely as an example and to facilitate understanding of the operation of the present invention, and is not to be seen as limiting the invention as is readily understood by the person skilled in the art. Thus, the width of the converting area is in this embodiment 2300 mm and the individual positions of the tool heads 31A-31F may be designated by their distance from any given reference point. Such a point may be given by the point P on the conveyor arrangement 41 or by the individual position of one of the tool heads 31, or may optionally also be given as the distance from one end of the converting area 20. In the example given in FIG. 4, disclosing a first set of individual positions for the tool heads 31A-F, the distance from each of the tool heads to the next is 100 mm, 500 mm, 50 mm, 100 mm and 100 mm, respectively. All the tool heads 31A-31F are located in the first converting station 21.

FIG. 5 discloses the second set of individual positions where all the tool heads 31A-31F have been moved to the second converting station 22. The distance from each tool head 31A-31F may also have been altered, giving their individual intervals as 100 mm, 100 mm, 50 mm, 500 mm, and 100 mm, respectively.

In one embodiment, the desired movement of the tools heads 31 is determined as follows:

Depending on a configuration of a next packaging template, a starting position for each tool head 31 for producing said packaging template is given. These starting positions are designated as the second set of individual positions for the tool heads 31. The control unit uses the second set of individual positions together with a first set of individual positions given by the current position of each tool head 31 and determines a suitable combination of the first movement of the conveyor arrangement 41 and individual movements for each of the tool heads 31 in order to move from the first to the second individual positions according to desired criteria. Such criteria can be to perform the movement as quickly as possible through a combination of a large first movement and smaller second movements, or alternatively to perform the movement through as small total movement as possible of all the tool heads 30 taken together. Other criteria may of course also be applied.

After the first and second movements have been decided, instructions are transmitted to each of the individual transport mechanisms 60 and to the joint transport mechanism 40 that then act to perform the second movements and the first movement, respectively.

Preferably, a point P on the conveyor arrangement 41 is used as a reference when determining the second movements of each tool head 31. The point P can be a center point in the converting station 21, 22 or can be and end point at one end of the converting station 21, 22. It may also be an arbitrarily selected point somewhere along the conveyor arrangement 41.

Preferably, the movements of the tool heads 30 are determined by first providing a first set of individual positions and a second set of individual positions. Then, a first movement of the transport mechanism and a second movement of each of the tool heads are determined, said first movement and second movement being selected for together transporting the tool heads from the first set of individual positions to the second set of individual positions. The first movement is then preferably selected so that the second movement of each tool head is minimized, i.e. so that the larger motor powering the conveyor arrangement 41 performs as much of the actual movement as possible. This is time efficient as well as power efficient.

The method according to the present invention may be carried out in a data processing apparatus that comprises means suitable therefore, for instance a computer, microcomputer or similar. Instructions resulting in the steps of the method disclosed herein may also be stored in the form of a computer program product on a computer-readable medium, such as a hard drive, memory device, disc or USB. The control unit mentioned above may comprise preprogrammed data relating to the desired movements from the first set of individual positions to the second set of individual positions, but may also be able to receive dynamic input from a user through a suitable input such as a touchscreen, keyboard or similar, and may also provide output to the user through any suitable output.

Furthermore, it is to be noted that all embodiments of the present invention described herein may freely be combined with each other, unless it is explicitly stated that such a combination would be unsuitable.

1. Tool head positioning device for a converting machine for converting sheet material into box templates, comprising:
a plurality of tool heads arranged in a converting area and able to act on sheet material being transported through said converting area,
a joint transport mechanism having a conveyor arrangement that is arranged to be coupled to each of the tool heads and to perform a first movement of the plurality of tool heads within the converting area by the conveyor arrangement moving together with the tool heads,
a plurality of individual transport mechanisms, each arranged at a tool head and able to perform a second movement of that tool head in relation to the conveyor arrangement,
wherein the joint transport mechanism and the plurality of individual transport mechanisms are arranged to move the plurality of tool heads from a first set of individual positions to a second set of individual positions, and wherein the second movement takes place during the first movement.

2. Tool head positioning device according to claim 1, wherein the conveyor arrangement comprises a toothed belt.

3. Tool head positioning device according to claim 1, wherein the conveyor arrangement comprises a rack, a belt, a chain or a wire.

4. Tool head positioning device according to claim 1, wherein the conveyor arrangement is permanently coupled to each of the tool heads.

5. Tool head positioning device according to claim 1, further comprising an attachment mechanism for attaching each tool head to the conveyor arrangement, said attachment mechanism preferably comprising clamps for clamping each tool head to the conveyor arrangement.

6. Tool head positioning device according to claim 1, wherein the individual transport mechanisms each comprise a motor connected to the tool head, wherein said motor acts on the conveyor arrangement to move the tool head along the conveyor arrangement.

7. Tool head positioning device according to claim 1, wherein each tool head is connected with an individual transport mechanism for moving the tool heads along the conveyor arrangement.

8. Tool head positioning device according to claim 1, wherein the converting area comprises at least two converting stations arranged side-by-side, and wherein the first set of individual positions is located at one of the converting stations and the second set of individual positions is located at another.

9. Method for positioning a plurality of tool heads in a converting machine for converting sheet material into box templates, comprising
providing a plurality of tool heads located at a first set of individual positions within a converting area,
moving the plurality of tool heads within the converting area in a first movement by means of a transport mechanism that is arranged to be coupled individually to each tool head,
moving at least one of the plurality of tool heads in relation to the transport mechanism in a second movement,
wherein the plurality of tool heads are moved to a second set of individual positions by the first and second movement, and wherein the second movement takes place during the first movement.

10. Method for positioning a plurality of tool heads according to claim 9, wherein the first movement is performed by a conveyor arrangement of the transport mechanism being coupled to each tool head and acting as a carrier for bringing the tool heads along.

11. Method for positioning a plurality of tool heads according to claim 10, wherein the conveyor arrangement is permanently coupled to the tool heads.

12. Method for positioning a plurality of tool heads according to claim 10, wherein the conveyor arrangement is coupled to the tool heads before the first movement and uncoupled afterwards.

13. Method for positioning a plurality of tool heads according to claim 9, wherein the converting area comprises at least two converting stations arranged side-by-side, and wherein the first and second movements move the tool heads from the first set of individual positions in one of the converting stations to the second set of individual positions in another.

14. Method according to claim 10, further comprising using the first and second sets of individual positions to determine a desired first movement of the conveyor arrangement and corresponding desired second movements of the tool heads in relation to the conveyor arrangement, and to perform said desired first and second movements to arrive at the second set of individual positions for the tool heads.

15. Method according to claim 9, further comprising
providing a first set of individual positions and a second set of individual positions
determining the first movement of the transport mechanism and the second movement of each of the tool heads, said first movement and second movement being selected for together transporting the tool heads from the first set of individual positions to the second set of individual positions
wherein the first movement is selected so that the second movement of each of the tool heads minimized.

16. A data processing apparatus comprising means for carrying out the method of claim 9.

17. A computer program product comprising instructions which, when the program is executed by a computer, cause the computer to carry out the method of claim 9.

18. A computer-readable medium comprising instructions which, when executed by a computer, causes the computer to carry out the method of any of claim 9.
